(19) United States
(12) Patent Application Publication
(10) Pub. No.: US 2016/0087750 A1
(43) Pub. Date: Mar. 24, 2016

(54) METHOD AND APPARATUS FOR TRANSMITTING ORTHOGONAL FREQUENCY DIVISION MULTIPLEXING (OFDM) SIGNAL IN OPTICAL NETWORK

(71) Applicant: ELECTRONICS AND TELECOMMUNICATIONS RESEARCH INSTITUTE, Daejeon-si (KR)

(72) Inventors: Hun Sik KANG, Daejeon-si (KR); Kyeong Hwan DOO, Daejeon-si (KR); Seung Hyun CHO, Daejeon-si (KR)

(21) Appl. No.: 14/862,588

(22) Filed: Sep. 23, 2015

(30) Foreign Application Priority Data
Sep. 24, 2014 (KR) 10-2014-0127902

(51) Int. Cl. H04J 14/02; H04W 28/02; H04L 5/00

(52) U.S. Cl. CPC H04J 14/0298; H04L 5/0007; H04W 28/0289

(57) ABSTRACT

A method for transmitting an orthogonal frequency division multiplexing (OFDM) signal in an optical network and apparatus therefor are provided. The method includes: converting a media access control (MAC) frame into an OFDM frame that contains a physical (PHY) level preamble, using the MAC frame which is transmitted from a MAC layer in a passive optical network (PON) to a PHY layer in an OFDM-PON; and transmitting the generated OFDM frame.

### CROSS-REFERENCE TO RELATED APPLICATION(S)

This application claims priority from Korean Patent Application No. 10-2014-0127902, filed on Sep. 24, 2014, in the Korean Intellectual Property Office, the disclosure of which is incorporated herein by reference in its entirety.

### BACKGROUND

1. Field

The following description relates to a technology for processing and transmitting a signal in an optical network.

2. Description of the Related Art

An optical network consists of an optical line terminal (OLT), an optical network unit (ONU), and an optical distribution network (ODN). An OLT is installed at a service provider or communication service provider side; an ONU is installed at a subscriber side; and an ODN is for optical signal transmission between the OLT and the ONU. Since optical components or an optical system in the ODN consists of passive devices only, the ODN is also referred to as a “passive optical network (PON)”.

An orthogonal frequency division multiplexing (OFDM) scheme, capable of transmitting data at high speed and providing good bandwidth scalability, is widely used for wireless/wired communications and can be applied to a PON. For an application of the OFDM to the PON, what is needed is a specific technology, which can increase transmission speed and transmission efficiency for transmission and reception of OFDM signals, without changing the existing structure of the ODN.

### SUMMARY

The following description relates to a method and apparatus for transmitting an orthogonal frequency division multiplexing (OFDM) signal in an optical network, which are capable of increasing transmission efficiency by preventing the occurrence of overhead that is used for transmission of an OFDM signal.

In one general aspect, there is provided a method for transmitting an orthogonal frequency division multiplexing (OFDM) signal in an optical network, the method including: converting a media access control (MAC) frame into an OFDM frame that contains a physical (PHY) level preamble, using the MAC frame which is transmitted from a MAC layer in a passive optical network (PON) to a PHY layer in an OFDM-PON; and transmitting the generated OFDM frame.

In the converting of the MAC frame into the OFDM frame that contains the PHY-level preamble, at least a part of the MAC frame may be used to generate the PHY-level preamble used for transmission of the OFDM frame so that overhead incurred by adding an additional PHY-level preamble and overhead incurred by line coding are eliminated, thereby making it possible to increase transmission efficiency.

The MAC frame may contain a laser synchronization pattern, burst delimiter, an idle character, a start frame delimiter, MAC layer data, forward error correction (FEC), and a burst terminator pattern.

The converting of the MAC frame into the OFDM frame may include: receiving the MAC frame from the MAC layer in the PON through the PHY layer in the OFDM-PON; obtaining layer synchronization pattern information from the received MAC frame; and modulating the obtained laser synchronization pattern information by mapping it into short training field (STF) symbols that indicate detection and start of an OFDM signal.

In the modulating of the laser synchronization pattern information, a laser synchronization pattern which consists of repetitions of the same bit sequence may be transformed into a plurality of symbols using a specific bit and correlation between symbols which are predefined according to a modulation scheme; and values of the resultant symbols undergo inverse Fourier transformation.

In the modulating of the laser synchronization pattern information, the modulation may be performed using a binary phase shift keying (BPSK) scheme or a quadrature phase shift keying (QPSK) scheme.

The converting of the MAC frame into the OFDM frame may include: receiving the MAC frame from the MAC layer in the PON from the PHY layer in the OFDM-PON; obtaining burst delimiter information from the received MAC frame; and modulating the obtained burst delimiter information by mapping it into long training field (LTF) symbols for channel estimation of an OFDM signal.

The converting of the MAC frame into the OFDM frame may include: receiving the MAC frame from the MAC layer in the PON from the PHY layer in the OFDM-PON; obtaining idle character information from the received MAC frame; and modulating the obtained idle character information by mapping it into LTF symbols for estimation of frequency offset of an OFDM signal.

The converting of the MAC frame into the OFDM frame may include: receiving the MAC frame from the MAC layer in the PON from the PHY layer in the OFDM-PON; obtaining preamble and start delimiter information from the received MAC frame; and modulating the obtained preamble and start delimiter information into information that indicates the beginning of data in the MAC frame.

The converting of the MAC frame into the OFDM frame may include: receiving the MAC frame from the MAC layer in the PON from the PHY layer in the OFDM-PON; obtaining burst terminator pattern information from the obtained MAC frame; and modulating the obtained burst terminator pattern information into information that indicates termination of a burst in the MAC frame.

In the modulating of the burst terminator pattern information, the burst terminator pattern may be modulated using a different modulation scheme from that used for the laser synchronization pattern, so as to be easily distinguished from the laser synchronization pattern.

In another general aspect, there is provided an apparatus for transmitting an OFDM signal in an optical network, the apparatus including: a processor configured to receive a media access control (MAC) frame from a MAC layer in a PON through a PHY layer in an OFDM-PON and use the received MAC frame to convert the MAC frame into an OFDM frame that contains a PHY-level preamble; and a transmitter configured to transmit the OFDM frame generated by the processor.

Other features and aspects will be apparent from the following detailed description, the drawings, and the claims.

### BRIEF DESCRIPTION OF THE DRAWINGS

FIG. 1 is a diagram illustrating a configuration of an orthogonal frequency division multiplexing (OFDM)-based passive optical network (PON) system according to an exemplary embodiment.

FIG. 2 is a diagram illustrating a frame structure that shows an overhead incurred during transmission of OFDM signal and the resulting reduced transmission efficiency.

FIG. 3 is a diagram illustrating PON architecture and a frame structure for when a line coding technique is used.

FIG. 4 is a diagram illustrating a network architecture and a frame structure for generating an OFDM signal that contains a P-preamble using a MAC frame, according to an exemplary embodiment.

FIG. 5 is a diagram illustrating in detail the MAC frame and the OFDM frame that contains the P-preamble of FIG. 4.

FIG. 6 is a diagram illustrating an example of symbol mapping for transforming a laser synchronization pattern into short training field (STF) symbols according to an exemplary embodiment.

FIG. 7 is a graph showing STF symbols transformed from the laser synchronization pattern according to an exemplary embodiment.

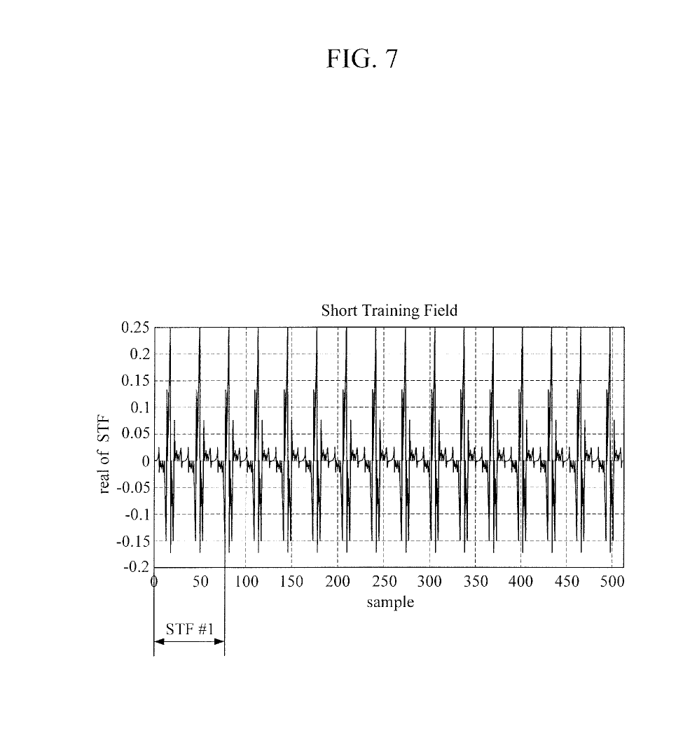

FIG. 8 is a graph showing long training field symbols transformed from burst delimiter signal according to an exemplary embodiment.

FIG. 9 is a diagram illustrating a configuration of an OFDM signal transmission apparatus in an OFDM-PON according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

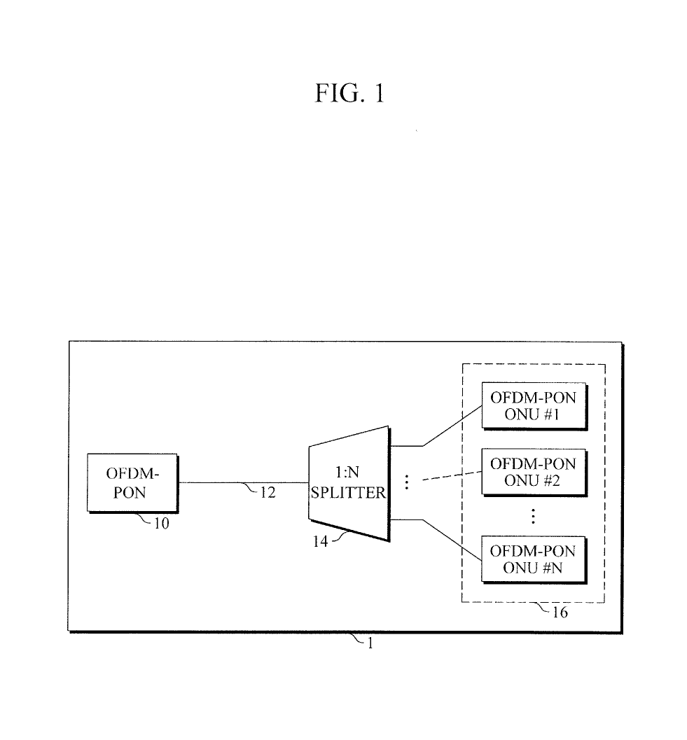

FIG. 1 is a diagram illustrating a configuration of an orthogonal frequency division multiplexing (OFDM)-based passive optical network (PON) system according to an exemplary embodiment.

Referring to FIG. 1, the OFDM-PON system 1 consists of: an OFDM-PON optical line terminal (OLT) 10 installed at a service provider or communication service provider side; one or more OFDM-PON optical network units (ONUs) 16 installed at a subscriber side; and optical fiber 12 for optical signal transmission between the OLT 10 and the ONUs 16. A 1:N splitter 14 is interposed between the OFDM-PON OLT 10 and the OFDM-PON ONUs 16.

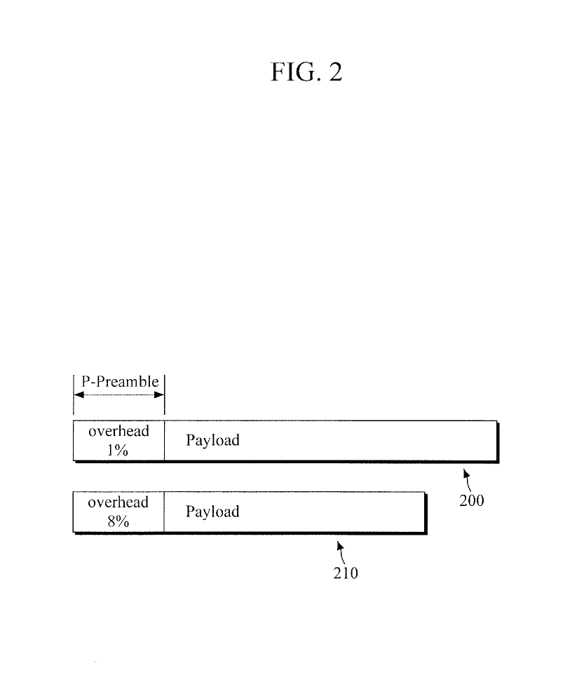

FIG. 2 is a diagram illustrating a frame structure that shows overhead incurred during transmission of OFDM signal and the resulting, reduced transmission efficiency.

A PON environment consists of a medium access control (MAC) layer and a physical (PHY) layer, wherein the MAC layer serves to control access of an optical transmission medium, such as transmission relay and flow control between a plurality of ONUs and a single OLT, and the PHY layer is in charge of coding, as well as the physical transmission of signals, so that data can be properly transmitted.

In this network structure, for transmission/reception of OFDM signals, additional information is generated in the PHY layer, in addition to data transmitted from the MAC layer. The additional information is referred to as a PHY-level preamble (hereinafter, will be referred to as a “P-preamble”), which is used to provide information regarding OFDM signal detection, channel estimation, and calibration of frequency and sampling clock offset. Such additional information causes an increase of overhead in transmission time when the data transfer rate at the PHY layer increases, and thereby reducing transmission efficiency. For example, as shown in FIG. 2, in the case of adding a P-preamble to a transmission frame, if the quadrature phase shift keying (QPSK) scheme is used to modulate data to be transmitted, a transmission frame 200 has a relatively large payload and hence has relatively small overhead. On the other hand, if the 64-quadrature amplitude modulation (QAM) scheme is used to modulate data to be transmitted, more data can be transmitted per symbol of an OFDM signal and thus a payload of a transmission frame 210 is shortened, resulting in increased overhead a consequent reduction in transmission efficiency.

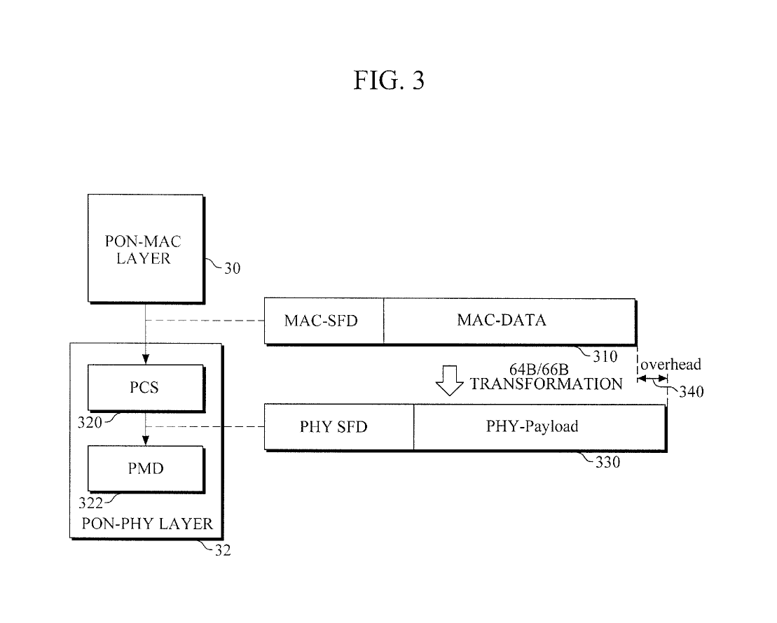

FIG. 3 is a diagram illustrating PON architecture and a frame structure for when a line coding technique is used.

Referring to FIG. 3, in a time-division multiplexing (TDM)-based PON, such as 1 Gbps EPON, 10 Gbps EPON, 2.5 Gbps GPON, or 10 Gbps XG-PON, which does not use the OFDM scheme, the PHY layer 32 transmits data in pulse Non-Return-to-Zero (NRZ) format or in Return-to-Zero (RZ) format. At this time, a physical coding sublayer (PCS) 320 of the PHY layer 32 performs line coding on data 310 that has been received from the MAC layer 30, and thereafter the PCS 320 sends the line-coded data through a physical medium dependent sublayer (PMD) 322. The line coding refers to coding of MAC data such that a transmission medium, such as an optical fiber, can transmit a signal in the form of a pulse. For example, as shown in FIG. 3, a 10G PON uses 64B/66B, which is a line code that transforms 64-bit MAC data to 66-bit line code. As shown in FIG. 3, it can be seen that extra overhead 340 is incurred when line coding is performed.

However, in an OFDM-PON in which the OFDM signal is used, OFDM modulation does not require the line-coded data that is used in the PHY layer of PON, as described with reference to FIG. 3. As described with reference to FIG. 2, in the existing OFDM-PON, additional information is added to data received from the MAC layer. As a data transfer rate of the PHY layer increases, such additional information increases overhead in transmission time, which results in reduction in transmission efficiency.

According to the present disclosure, a P-preamble necessary for OFDM signal transmission is generated in the PHY layer using data received from the MAC layer. In other words, unlike the existing PON where a P-preamble signal is newly added to the data received from the MAC layer, according to the exemplary embodiment, a P-preamble signal is generated using a part of data received from the MAC layer. Accordingly, it is possible to eliminate overhead which is incurred by adding a preamble in the PHY level, as described with reference to FIG. 2, as well as extra overhead which is incurred by line coding, as described with reference to FIG. 3. Consequently, the transmission efficiency can be increased. Furthermore, the data received from the MAC layer is used in generating P-preamble, thereby making it possible to simplify procedures of signal processing. A P-preamble signal creation technology using a MAC frame will be described in detail with reference to the accompanying drawings, in which exemplary embodiments are shown.

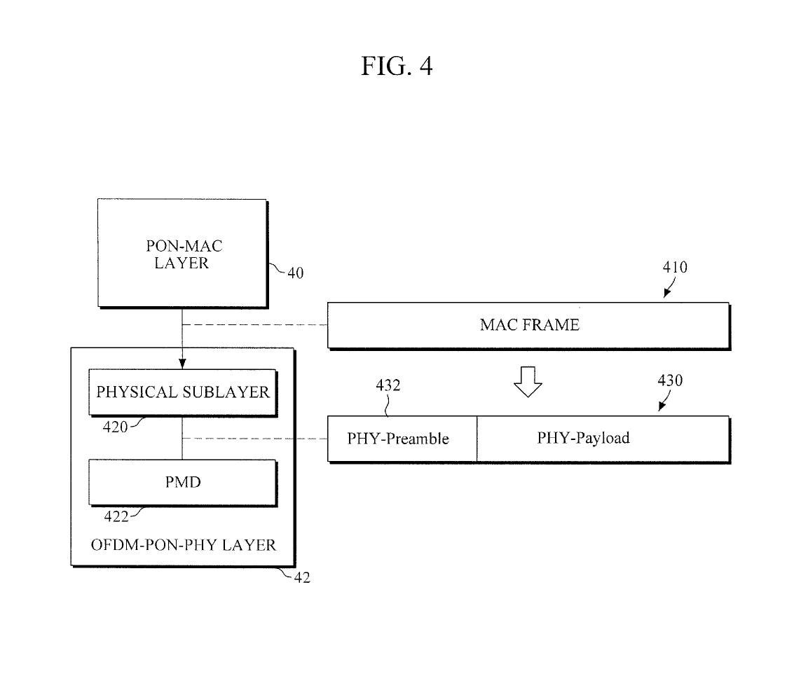

FIG. 4 is a diagram illustrating a network architecture and a frame structure for generating an OFDM signal that contains a P-preamble using a MAC frame, according to an exemplary embodiment.

Referring to FIG. 4, when receiving a MAC frame 410 from a PON-MAC layer 40, a physical sublayer 420 of an OFDM-PON PHY layer 42 converts the received MAC frame 410 into an OFDM frame 430 that contains a PHY-level preamble 432. A physical medium dependent sublayer (PMD) 422 transmits the generated OFDM frame 430. At this time, the physical sublayer 420 uses at least a part of the MAC frame 410 to generate a PHY preamble for transmission of the OFDM frame 430, so that it is possible to eliminate both the overhead incurred when an additional PHY-level preamble is added and the overhead incurred when line coding is performed, and to thereby increase the transmission efficiency.

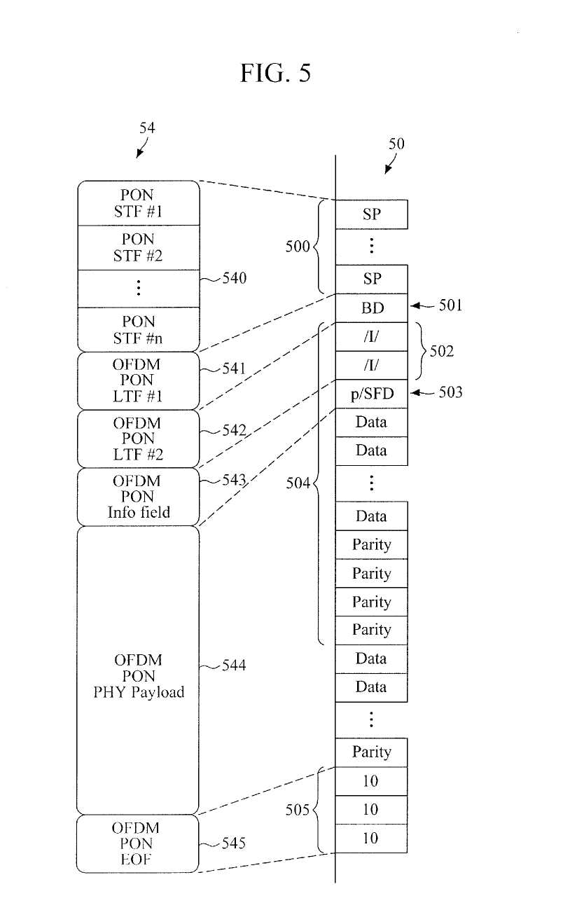

FIG. 5 is a diagram illustrating in detail the MAC frame and the OFDM frame that contains the P-preamble of FIG. 4.

To further assist an understanding of the present disclosure, FIG. 5 shows an example in which a MAC frame used in a 10G E-PON is converted into a frame for generating an OFDM signal to be used in the OFDM-PON. Values and attributes of information in each frame may vary according to an environment to which it is applied.

Referring to FIG. 5, a MAC frame 50 that is transmitted from the MAC layer to the PHY layer contains various types of data, such as a laser synchronization pattern (SP) 500, burst delimiter (BD) 501, an idle character (/I/) 502, preamble/start frame delimiter (p/SFD) 503, MAC data, forward error correction (FEC) (4 Parity) 504 for error recovery, burst terminator pattern 505, and the like.

Specifically, the laser synchronization pattern (SP) 500 enables a light source, i.e., laser, to be turned on/off and allows for amplitude matching of laser. The burst delimiter (BD) 501 indicates the beginning of a burst in the MAC frame. The preamble/start frame delimiter (p/SFD) 503 indicates the beginning of data in the MAC frame and logical link ID information. The burst terminator pattern 505 indicates the burst termination of the MAC frame.

The MAC frame 50 with the aforesaid data is used to generate a P-preamble for transmitting the OFDM signal 54. The P-preamble is used in various operations required for smooth transmission/reception of the OFDM signal 54 in the OFDM-PON. The operations may be, for example, signal detection, gain control, OFDM symbol synchronization, frequency synchronization, and channel estimation.

In one exemplary embodiment, the OFDM signal transmission apparatus transforms the laser synchronization pattern (SP) 500 into a short training field (STF) symbol that indicates the detection and start of an OFDM signal. Here, a symbol refers to one OFDM symbol. The laser synchronization pattern (SP) 500 consists of repetitions of a bit sequence of 01010101(0X55) and its length information is transmitted when the OLT transmits multi-point control protocol data unit (MPCPDU) to the ONU.

Since the STF symbol is important information that indicates the beginning of a signal, the laser synchronization pattern (SP) 500 needs to be transformed to STF symbols that are so robust, they can withstand channel conditions or noise of an optical fiber and thus be recoverable upon receipt thereof. To this end, the transformation may need to be performed using a binary phase shift keying (BPSK) or QPSK scheme, which allows for the reception of information even when the signal-to-noise ratio (SNR) is low. In one exemplary embodiment, the OFDM signal transmission apparatus transforms the laser synchronization pattern (SP) 500, which consists of repetitions of the same bit sequence, into a plurality of symbols using specific bits and correlations between symbols, which are predefined by a modulation scheme, and the apparatus performs inverse fast Fourier transformation (IFFT) on the symbol values.

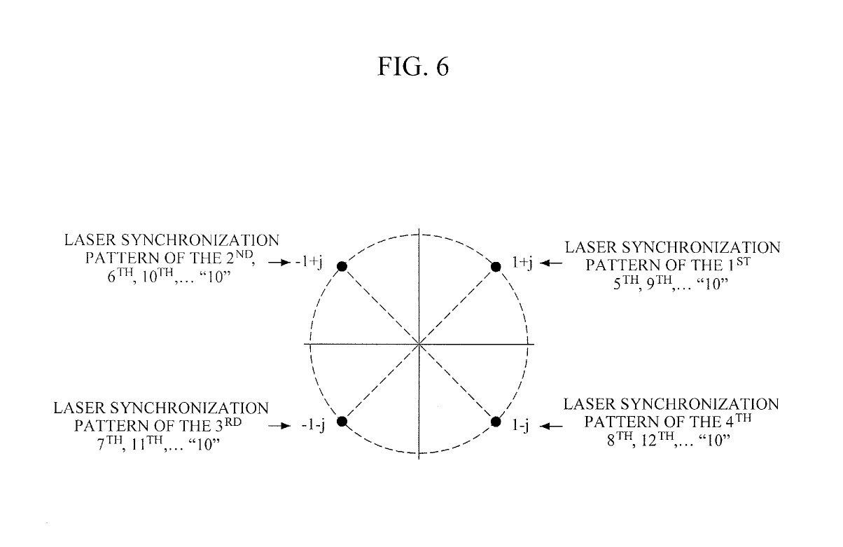

For example, as shown in FIG. 6, when the laser synchronization pattern (SP) 500, represented in binary pattern 10101010, is modulated according to the QPSK scheme, it is transformed into complex symbols. More specifically, the pattern's first segment ‘10’ is mapped into a QPSK value of 1+j; the second segment ‘10’ is mapped into a 90 degree counter-clockwise turn of the first segment; the next segment ‘10’ is mapped into a value of −1−j; and so forth. Thereafter, the mapping results undergo inverse fast Fourier transformation (IFFT).

In the IFFT, the symbols are mapped into subcarriers such that the STF symbol output is represented by repetitions of output values of IFFT units in order to facilitate signal detection and gain control. For example, in the case of 64-point IFFT, if symbol mapping is performed on the laser synchronization pattern (SP) 500 according to a method as described with reference to FIG. 6 and then the result undergoes IFFT as shown in Table 1 below, the STF symbol is represented by repetitions of the same form. Hence, when an OFDM signal is received, the start of the OFDM signal can be identified through delayed autocorrelation.

TABLE 1

| IFFT Subcarrier | |
|---|---|
| Position | Value to Be Mapped |
| 1~4 | 0 |
| 5 | 1 − j |
| 6 | −1 − j |
| 7 | −1 + j |
| 8 | 1 + j |
| 9 | 1 − j |
| 10 | −1 − j |
| 11 | −1 + j |
| 12 | 1 + j |
| 13~20 | 0 |
| 21 | 1 − j |
| 22 | −1 − j |
| 23 | −1 + j |
| 24 | 1 + j |
| 25 | 1 − j |
| 26 | −1 − j |
| 27 | −1 + j |
| 28 | 1 + j |
| 29~32 | 0 |
| 33~64 | Value mirroring the above values from 1 to 32 |

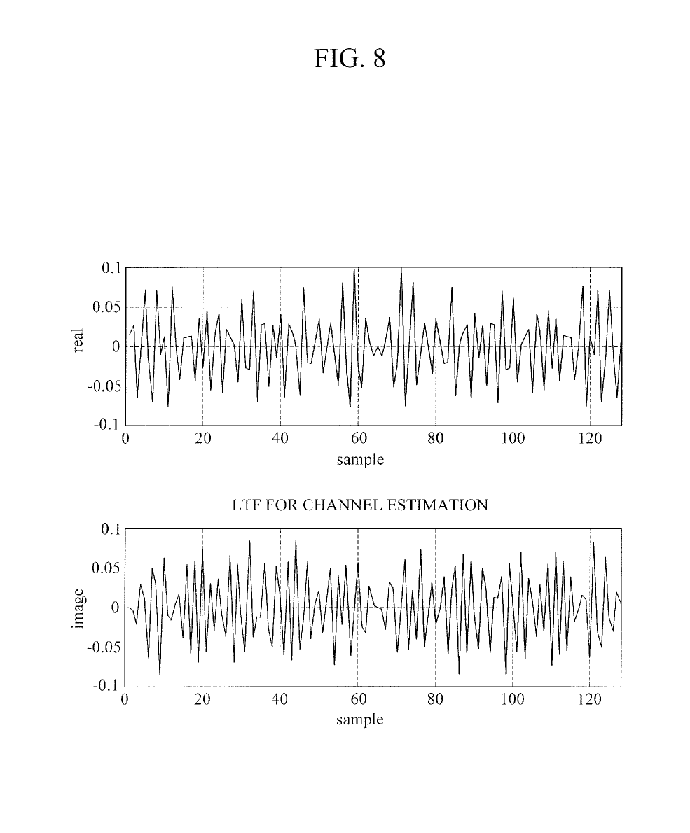

The burst delimiter (BD) 501 following the laser synchronization pattern (SP) 500 of the MAC frame 50 indicates the start of a burst signal of the MAC frame 50 and has a total of 66 bits, whose value is 0X6BF8D812D858E4AB, represented in hexadecimal. The burst delimiter (BD) 501 is used as channel estimation information, which is required for compensating for inter-symbol interference and a distortion of a signal according to channel conditions of the optical fiber during the transmission of the OFDM signal. More accurate channel estimation is possible if a channel response within an OFDM effective band is known, and thus the values of all bits are mapped into the effective bandwidth of available IFFT. First, to map the bit signals into symbols for OFDM modulation, the modulation is performed using the BPSK scheme so that available signals among said signals can be recovered as received. For example, bit “0” is transformed to a BPSK symbol of −1 and bit “0” is transformed to a BPSK symbol of 1, after which they undergo IFFT. FIG. 8 shows a long training field (LTF) signal when segments of a signal of bust delimiter (BD) 151 are sequentially mapped into the 32^{nd} to 97^{th} (starting from the 1^{st}) subcarriers in the case of 128-point IFFT.

After channel estimation, the receiver side requires frequency offset information in order to reduce reception error due to offsets of transmission/reception carriers or sampling clocks. Idle character information (/I/) 502 of the MAC frame 50 is used to provide frequency offset information. The idle character information (/I/) 502 received from the MAC layer consists of 66 bits. Two pieces of idle character information (/I/) 502 are transmitted to the PHY layer and used in frequency offset estimation. In this case, each bit of the information is modulated using the BPSK scheme, the entire BPSK symbols are mapped into effective subcarriers, and then an inverse-fast-Fourier-transformed signal is transmitted. As a result, two OFDM symbols with the same pattern are generated and frequency offset can be estimated based on phase difference between the two symbols caused by the frequency offset.

Data of the MAC frame 50 transmitted from the MAC layer starts with the p/SFD 503. The p/SFD 503 contains 0x55, SLD, 0x55, 0x55, LLID (2 octet), and CRC-8. The p/SFD 503 is information that indicates the beginning of data in the MAC frame 50. Hence, if the reception of p/SFD 503 fails, data recovery of the MAC frame 50 is not possible. The p/SFD 503 is modulated using the BPSK scheme and transmitted in order to enable smooth reception of the p/SFD 503.

As a data transfer rate varies according to the transmission service of the ONU, QAM symbol generation may be variably available for the data of MAC frame 50. In the case of high-speed data, the data may be modulated using the 64-QAM method and then transmitted, and in the case of low-speed data, it may be modulated using the BPSK scheme and then transmitted. The modulation scheme may be determined during the initial setup process of the OLT and the ONU, and information on the determined method is transmitted from the PON-MAC layer to the OFDM-POM-PHY layer.

The burst terminator pattern 505, which indicates the termination of the MAC frame 50, starts with 0x55 and is modulated using a different modulation scheme from that used for the laser synchronization pattern 500, so as to be easily distinguished from the laser synchronization pattern (SP) 500 in the OFDM-PON-PHY layer. Accordingly, the termination point of the OFDM signal can be easily identified. For example, if the laser synchronization pattern (SP) 500 is modulated using the QPSK scheme, the burst terminator pattern 505 is modulated using the BSPK scheme.

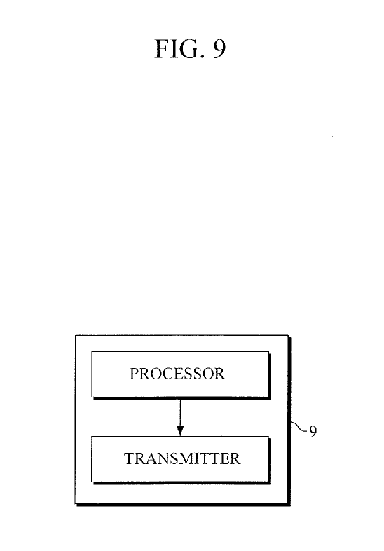

FIG. 9 is a diagram illustrating a configuration of an OFDM signal transmission apparatus in an OFDM-PON according to an exemplary embodiment.

Referring to FIG. 9, the OFDM signal transmission apparatus 9 includes a processor 90 and a transmitter 92. The processor 90 and the transmitter 92 both may be located in the OFDM-PON-PHY layer. The processor 90 may serve a function that corresponds to the physical sublayer 420 in the network architecture of FIG. 4. The transmitter 92 may serve a function that corresponds to the PMD 422.

The processor 90 may receive a MAC frame through the PHY layer of OFDM-PON from the MAC layer of PON and convert the received MAC frame to an OFDM frame that contains P-preamble. Then, the transmitter 92 transmits the OFDM frame generated in the processor 90. The processor 90 and the transmitter 92 are both located on the PHY layer.

In one exemplary embodiment, the processor 90 uses at least a part of the MAC frame to generate a P-preamble for OFDM frame transmission, thereby eliminating the overhead caused by the addition of an additional preamble, as well as the overhead caused during line coding, and thus increasing the transmission efficiency.

In one exemplary embodiment, the processor 90 obtains laser synchronization pattern information from the MAC frame received from the MAC layer of PON through the PHY layer of OFDM-PON, and thereafter, the processor 90 modulates the obtained laser synchronization pattern information by mapping it into STF that indicates the detection and start of an OFDM signal.

In one exemplary embodiment, the processor 90 obtains burst delimiter (BD) information from the MAC frame received from the MAC layer of PON through the PHY layer of OFDM-PON and modulates the obtained BD information by mapping it into LTF for an OFDM signal channel estimation.

In one exemplary embodiment, the processor 90 obtains idle character information (/I/) from the MAC frame received from the MAC layer of PON through the PHY layer of OFDM-PON and modulates the obtained idle character information by mapping it into LTF for an OFDM signal frequency offset estimation.

In one exemplary embodiment, the processor 90 obtains preamble and start frame delimiter (p/SFD) information from the MAC frame received from the MAC layer of PON through the PHY layer of OFDM-PON and modulates the obtained p/SFD information to information that indicates the beginning of data in the MAC frame.

In one exemplary embodiment, the processor 90 obtains burst terminator pattern information from the MAC frame received from the MAC layer of PON through the PHY layer of OFDM-PON and modulates the obtained burst terminator pattern information to information that indicates the termination of the burst in the MAC frame.

According to the exemplary embodiments as described above, a P-preamble signal required for transmission of an OFDM signal is generated using data transmitted from the PON-MAC layer to the OFDM-PON-PHY layer, so that the occurrence of overhead is prevented, resulting in an increase of transmission efficiency.

In other words, unlike the existing PON in which a P-preamble signal is newly added to data received from the MAC layer, a part of data transmitted from the MAC layer is used to generate a P-preamble signal, so that the occurrence of overhead incurred by adding a preamble signal in the PHY level, as well as the occurrence of extra overhead incurred by line coding can be prevented, thereby increasing the transmission efficiency. Furthermore, data transmitted from the existing MAC layer is used to generate the P-preamble signal so that the signal processing procedures can be simplified.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for transmitting an orthogonal frequency division multiplexing (OFDM) signal in an optical network, the method comprising:
converting a media access control (MAC) frame into an OFDM frame that contains a physical (PHY) level preamble, using the MAC frame which is transmitted from a MAC layer in a passive optical network (PON) to a PHY layer in an OFDM-PON; and
transmitting the generated OFDM frame.

2. The method of claim 1, wherein in the converting of the MAC frame into the OFDM frame that contains the PHY-level preamble, at least a part of the MAC frame is used to generate the PHY-level preamble used for transmission of the OFDM frame so that overhead incurred by adding an additional PHY-level preamble and overhead incurred by line coding are eliminated, thereby making it possible to increase transmission efficiency.

3. The method of claim 1, wherein the MAC frame contains a laser synchronization pattern, burst delimiter, an idle character, a start frame delimiter, MAC layer data, forward error correction (FEC), and a burst terminator pattern.

4. The method of claim 1, wherein the converting of the MAC frame into the OFDM frame comprises: receiving the MAC frame from the MAC layer in the PON through the PHY layer in the OFDM-PON; obtaining layer synchronization pattern information from the received MAC frame; and modulating the obtained laser synchronization pattern information by mapping it into short training field (STF) symbols that indicate detecting and start of an OFDM signal.

5. The method of claim 4, wherein in the modulating of the laser synchronization pattern information, a laser synchronization pattern which consists of repetitions of the same bit sequence is transformed into a plurality of symbols using a specific bit and correlation between symbols which are predefined according to a modulation scheme; and values of the resultant symbols undergo inverse Fourier transformation.

6. The method of claim 4, wherein in the modulating of the laser synchronization pattern information, the modulation is performed using a binary phase shift keying (BPSK) scheme or a quadrature phase shift keying (QPSK) scheme.

7. The method of claim 1, wherein the converting of the MAC frame into the OFDM frame comprises: receiving the MAC frame from the MAC layer in the PON from the PHY layer in the OFDM-PON; obtaining burst delimiter information from the received MAC frame; and modulating the obtained burst delimiter information by mapping it into long training field (LTF) symbols for channel estimation of an OFDM signal.

8. The method of claim 1, wherein the converting of the MAC frame into the OFDM frame comprises: receiving the MAC frame from the MAC layer in the PON from the PHY layer in the OFDM-PON; obtaining idle character information from the received MAC frame; and modulating the obtained idle character information by mapping it into LTF symbols for estimation of frequency offset of an OFDM signal.

9. The method of claim 1, wherein the converting of the MAC frame into the OFDM frame comprises: receiving the MAC frame from the MAC layer in the PON from the PHY layer in the OFDM-PON; obtaining preamble and start delimiter information from the received MAC frame; and modulating the obtained preamble and start delimiter information into information that indicates the beginning of data in the MAC frame.

10. The method of claim 1, wherein the converting of the MAC frame into the OFDM frame comprises: receiving the MAC frame from the MAC layer in the PON from the PHY layer in the OFDM-PON; obtaining burst terminator pattern information from the obtained MAC frame; and modulating the obtained burst terminator pattern information into information that indicates termination of a burst in the MAC frame.

11. The method of claim 10, wherein in the modulating of the burst terminator pattern information, the burst terminator pattern is modulated using a different modulation scheme from that used for the laser synchronization pattern, so as to be easily distinguished from the laser synchronization pattern.

12. An apparatus for transmitting an OFDM signal in an optical network, the apparatus comprising:
a processor configured to receive a media access control (MAC) frame from a MAC layer in a PON through a PHY layer in an OFDM-PON and use the received MAC frame to convert the MAC frame into an OFDM frame that contains a PHY-level preamble; and
a transmitter configured to transmit the OFDM frame generated by the processor.

13. The apparatus of claim 12, wherein the processor and the transmitter both are located in the PHY layer.

14. The apparatus of claim 12, wherein the processor uses at least a part of the received MAC frame to generate the PHY-level preamble for transmission of the OFDM frame so that overhead incurred by adding an additional PHY-level preamble and overhead incurred by line coding are eliminated, thereby increasing transmission efficiency.

15. The apparatus of claim 12, wherein the processor receives the MAC frame from the MAC layer in the PON through the PHY layer in the OFDM-PON; obtains layer synchronization pattern information from the received MAC frame; and modulates the obtained laser synchronization pattern information by mapping it into short training field (STF) symbols that indicate detecting and start of an OFDM signal.

16. The apparatus of claim 12, wherein the processor receives the MAC frame from the MAC layer in the PON from the PHY layer in the OFDM-PON; obtains burst delimiter information from the received MAC frame; and modulates the obtained burst delimiter information by mapping it into long training field (LTF) symbols for channel estimation of an OFDM signal.

17. The apparatus of claim 12, wherein the processor receives the MAC frame from the MAC layer in the PON from the PHY layer in the OFDM-PON; obtains idle character information from the received MAC frame; and modulates the obtained idle character information by mapping it into LTF symbols for estimation of frequency offset of an OFDM signal.

18. The apparatus of claim 12, wherein the processor receives the MAC frame from the MAC layer in the PON from the PHY layer in the OFDM-PON; obtains preamble and start delimiter information from the received MAC frame; and modulates the obtained preamble and start delimiter information into information that indicates the beginning of data in the MAC frame.

19. The apparatus of claim 12, wherein the processor receives the MAC frame from the MAC layer in the PON from the PHY layer in the OFDM-PON; obtains burst terminator pattern information from the obtained MAC frame; and modulates the obtained burst terminator pattern information into information that indicates termination of a burst in the MAC frame.
